(19) United States
(12) Patent Application Publication
(10) Pub. No.: US 2017/0006242 A1
(43) Pub. Date: Jan. 5, 2017

(54) METHOD FOR GLOBALLY RESETTING THE PIXELS IN A MATRIX IMAGE SENSOR

(71) Applicant: PYXALIS, Moirans (FR)

(72) Inventor: Grégoire CHENEBAUX, GRENOBLE (FR)

(21) Appl. No.: 15/107,086

(22) PCT Filed: Dec. 22, 2014
(86) PCT No.: PCT/EP2014/078949

§ 371 Date: Jun. 21, 2016

(30) Foreign Application Priority Data
Dec. 23, 2013 (FR) 1363428

(51) Int. Cl. H04N 5/353; H04N 5/363

(52) U.S. Cl. CPC H04N 5/3532; H04N 5/363

(57) ABSTRACT

Matrix image sensors with active pixels comprise a photodiode and transistors in each pixel, with at least one transistor for commanding the reset of a charge storage zone (photodiode or floating diffusion). To avoid reset potential value errors in large matrices, when a global reset is desired for all the matrix, the falling edge of the reset command signal is shifted in time before progressively staggered signals are applied to the reset command lines. Duly staggered individual reset command signals are applied to groups of X rows (X>=1). The command signals mutually overlap to minimize the time necessary for the global reset of all the matrix. Delay elements or shift registers are used to produce individual signals with staggered falling edges.

The invention relates to the matrix image sensors with active pixels comprising a photodiode and transistors in each pixel, with electronics for controlling the rows and columns of pixels to integrate charges generated by the light for a periodically refreshed determined time.

In these image sensors, it is necessary to reset the pixels on each integration cycle, to be able to read the charges generated by a measurement of the difference between an initialization potential level (not resulting from the illumination of the pixel) and a useful potential level resulting from the charges generated by the light.

Among the problems identified in image sensors with active pixels, there is the issue of the various noises which come to disturb the image: photon noise in weak illumination, temporal read noise, spatial noise (or fixed pattern noise, FPN) due to the dispersion of the characteristics of the pixels, or even space-time noise due both to the dispersion of the characteristics and to transient phenomena at the time of the resets.

In the sensors which operate with a global reset of the pixels, whether it is a global reset of all the photodiodes or a global reset of all the temporary charge storage nodes for the pixels which comprise a temporary storage node, a phenomenon of spatial or spatio-temporal noise has been observed which will now be explained.

The global reset applies a signal to start the conduction of a reset transistor contained in the pixel then stops the conduction; this transistor links the charge storage zone (photodiode or temporary storage node) to a reference potential which can be the general power supply potential of the matrix; this command, which is addressed to all the pixels of the matrix for a simultaneous reset of all the pixels, creates capacitive couplings that are very significant for large matrices, both at the start of the command and at the end of the command. The result thereof is disturbances of the reference potential. This reference potential undergoes strong transient fluctuations at these start and end instants of the global reset command. Now, this potential is used to define the reset level of the pixel, whether it is the reset level of a photodiode in a pixel with three transistors or the reset level of a charge storage node in a pixel with four or five transistors (or more than five transistors). If this level undergoes disturbances, the measurement of the quantity of charges resulting from the illumination of the pixel will be affected by an error. In effect, the measurement is made by observing the potential level of the photodiode or of the storage node after illumination, and this potential will not be the same depending on the reset level which will have been applied.

Furthermore, although there is just one global reset signal for all the matrix of pixels, the precise reset instant, that is to say the instant when the conduction of a reset transistor is blocked, can vary from one pixel to another in the large matrices because of the variable delays in propagation of the global signal to the different pixels; since the level of the reference potential is fluctuating because of the capacitive couplings, the reset potential levels can vary from one pixel to another, which generates a spatial noise in the image collected. This noise that is mainly fixed in a frame can vary from one frame to the next.

This defect relates to the so-called 3T pixels comprising a photodiode and three transistors, namely: a row select transistor, a transistor for reading the potential of the photodiode, and a transistor for resetting the potential of the photodiode. It also relates to the pixels with four transistors (4T) which comprise a photodiode and four transistors: a transistor for transferring charges from the photodiode to a temporary charge storage node, a transistor for resetting the potential of the charge storage node, a transistor for reading the potential of the storage node, and a row select transistor. In the case of pixels with four transistors, it is the resetting of the potential of the charge storage node which can pose a problem if it is global for all the matrix; in the case of pixels with five transistors (5T) that also have a transistor for resetting the photodiode, it is also the reset of the charge storage node which poses a problem. Hereinbelow, interest will be focused on the reset of a charge storage zone, which will be the reset of the temporary charge storage node when it exists (4T pixels, 5T pixels), or the reset of the photodiode, which is a charge storage zone, when there is no charge storage other than in the photodiode itself (3T pixels).

Throughout the following, the following expressions will apply:

global reset: a reset step which, from the point of view of the sequencing of the operations in the matrix, should ideally be done simultaneously in all the rows,

and successive reset steps: the reset steps which are, in principle, done row by row with a row-to-row time shift imposed by the conditions of integration of photogenerated charges and of reading of these charges.

Thus, in this description, a reset done row by row with a progressive time shift made necessary to obtain a same integration time in all the rows is not considered as a global reset but as an individual reset. It does not concern therefore the imaging systems which comprise a vertical rolling mechanical shutter (rolling in the direction of the columns of the matrix of pixels) and which comprise electronic means for compensating for the slowness of closure of the shutter. In effect, in these systems, a deliberate time shift, progressive from one row to the next, of the start instant of the integration time is produced electronically, and consequently by principle the reset of the pixels at the start of the integration time is not done globally, with the result that the problem mentioned above does not exist.

Thus, the invention applies mainly (but not exclusively) to imaging systems that do not have a mechanical shutter, or at the very least that do not have a vertical rolling mechanical shutter, the vertical direction corresponding to that of the columns of pixels.

Nor is a reset done row by row during a row-by-row read operation comprising, in order, the reading of a useful signal level of the pixels of the row followed by a reset of the pixels of the row followed by a read of the reset level of the pixels of the row, considered as a global reset, but as an individual reset. Here again, it is the principle of differential read, row-by-row, which requires the reset to be done successively row by row.

By contrast, a reset can be considered global when the shifts between reset signals are at least 10 or 100 times shorter than the durations of said reset signals.

In the case of the 4T or 5T pixels, the invention only concerns the global reset of the charge storage nodes preceding a transfer of useful charges generated by the light, for a read of the signal level generated by these useful charges, because it is this reset which poses the problem mentioned above.

In the case of the 3T pixels it concerns only the global reset of all the photodiodes before an integration of charges generated by the light.

The difficulty mentioned above could be resolved by dispensing with a global reset and by addressing the matrix row by row using a row decoder which in any case exists for the reading of the matrix; the reset of a single row does not provoke any significant disturbance of the reference potential. However that would take too much time and that would amount to an individual reset of the rows.

That is why, according to the invention, a method is proposed for globally resetting storage zones for charges generated by the light in the pixels of a matrix image sensor comprising rows and columns of pixels, before a row-by-row read of the charges generated by the light, characterized in that

a general global reset command signal is established having a rising edge and a falling edge,

from this general signal M individual reset command signals (M>1) are produced that are mutually overlapping and that have falling edges slightly staggered in time relative to one another and relative to the falling edge of the general signal, by means of circuit elements other than a simple conductor,

and each individual reset command signal is applied to a respective group of X rows of pixels, X being an integer greater than or equal to 1.

The mutual overlapping of the individual reset command signals is partial or, better, total. “Partial overlap” should be understood to mean the fact that each individual signal is overlapping with at least one other individual signal. “Total overlap” should be understood to mean the fact that all the individual signals are simultaneously active at at least one moment. The overlap makes it possible to minimize the time necessary for the global reset of all the matrix.

The shift time dT between the successive falling edges is very much less (approximately 100 to 1000 times lower when there is a dT element per row) than the time which would be necessary for the reset of a pixel. For example, if it takes approximately 5 microseconds to ensure the reset of a photodiode or of a temporary charge storage node, the time dT of the shift will preferably be less than 5 nanoseconds, even 1 nanosecond. If the groups of rows comprise more than one row, the time dT can be increased. This time dT is not necessarily identical from one group of rows to another.

By convention, it will be considered hereinbelow that the signals are active at the high level, and consequently that the rising edge activates the reset phase (by making the reset transistor conductive), whereas the falling edge stops the reset (by blocking the reset transistor). It will be understood that a reverse convention could have been adopted without changing the principle of the invention.

The rising edges can be simultaneous or staggered in time, but the falling edges are necessarily staggered. In effect, it is on the falling edge that the value of the reset potential, taken by the charge storage zone which is the photodiode for a 3T pixel or the temporary storage node for a 4T or 5T pixel, is fixed, and it is at that moment that power supply potential fluctuations must be avoided as far as possible.

The M individual command signals produced from the general command signal can be produced from M cascaded delay elements, the first of which receives the general command signal, the outputs of the M delay elements supplying M signals having falling edges staggered relative to one another. The duration of the general command signal is then greater than the sum of the delays when a total overlap is desired between all the individual reset signals. A delay element should be understood to be a circuit element that introduces a deliberate delay, obviously excluding a simple conductor which, by its non-zero resistance and capacitance, exhibits a very small but inevitable spurious delay.

The delays dT are not necessarily identical from one group of rows to the next.

In a preferred embodiment, the M individual command signals are produced from a shift register with serial input and with M parallel outputs, a register in which the shift is controlled by a clock signal of period dT; an input logic signal comprising a series of successive bits of the same logic level (by convention: level 1) is applied to the serial input of the register, the M individual command signals being produced from the outputs of the register during the shifting thereof. The duration of the reset command signal is defined by the number of bits of level 1 of the series applied to the input.

The M individual command signals can also be produced from a shift register with M flip-flops, the register having a serial input, parallel outputs and means for setting the high logic state simultaneously for all the flip-flops; the flip-flops are then initially set to the high state, then a low logic level is applied to the serial input of the register and the shift of the register is actuated with a period dT while the state of the input remains at the low logic level. The outputs of the M flip-flops of the register produce the M individual signals which all have the same rising edge but staggered falling edges.

Thus, according to the invention, although a global reset of all the pixels is applied at a given instant which should in principle be the same for all the pixels, a very slight shift is introduced between the rows of pixels notably to attenuate the uncertainty concerning the reset levels taken by the different pixels during this global reset.

The invention applies notably to all imaging systems with no vertical rolling mechanical shutter.

Other features and advantages of the invention will become apparent on reading the following detailed description which is given with reference to the attached drawings in which:

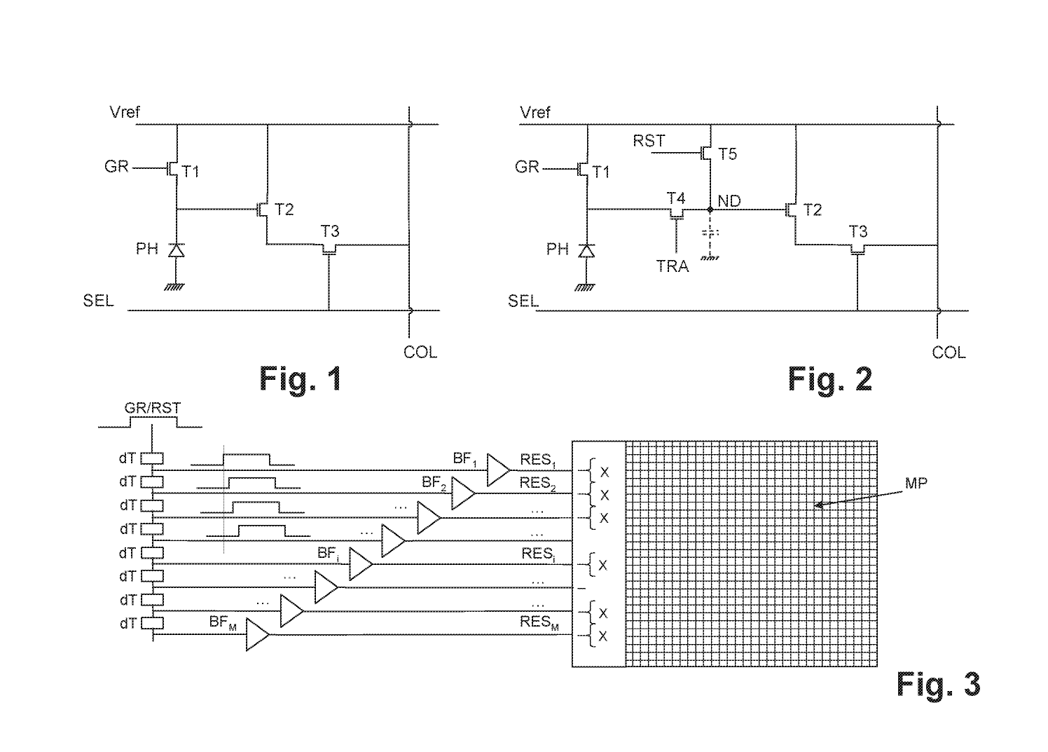

FIG. 1 represents the conventional electrical circuit diagram of a pixel with three transistors;

FIG. 2 represents the conventional electrical circuit diagram of a pixel with four or five transistors;

FIG. 3 represents an embodiment of a sensor that makes it possible to implement the invention;

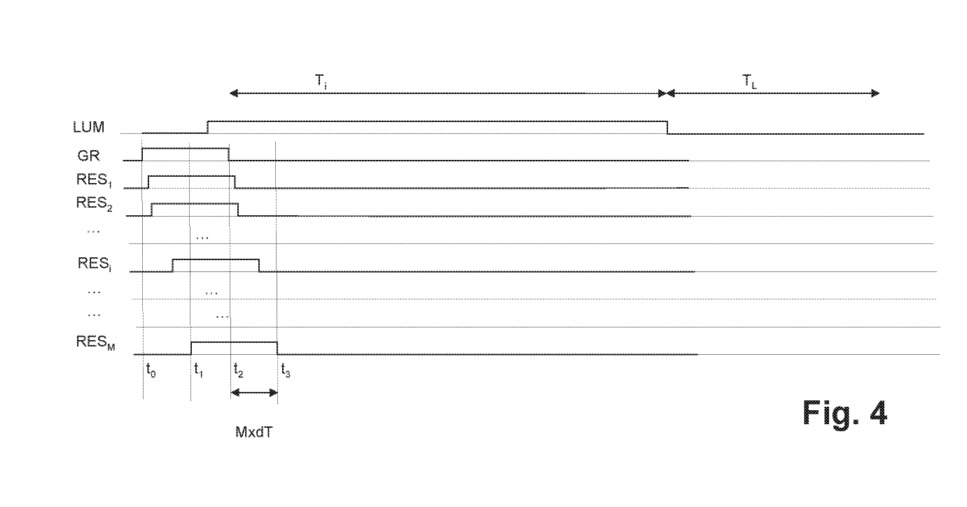

FIG. 4 represents a timing diagram of operation of the sensor for a matrix with 3T pixels;

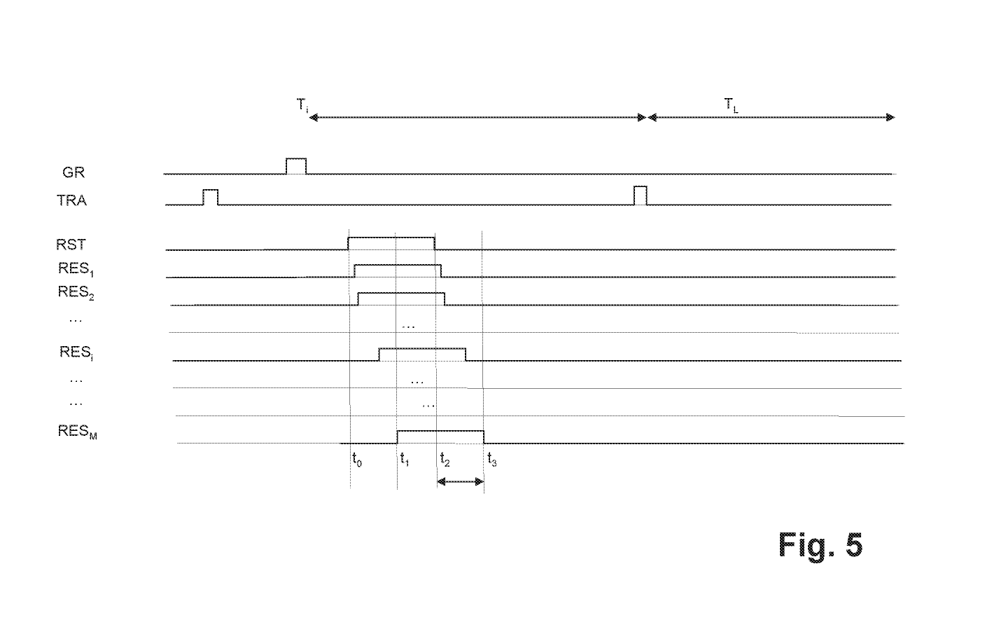

FIG. 5 represents a timing diagram of operation for a matrix with 5T pixels;

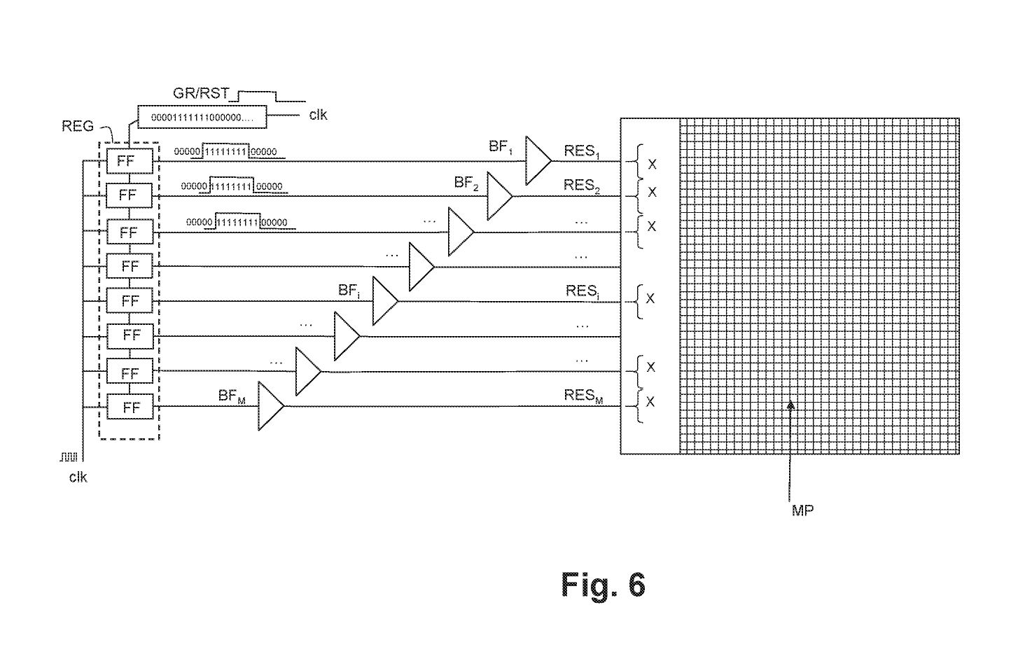

FIG. 6 represents another embodiment of a sensor that makes it possible to implement the invention;

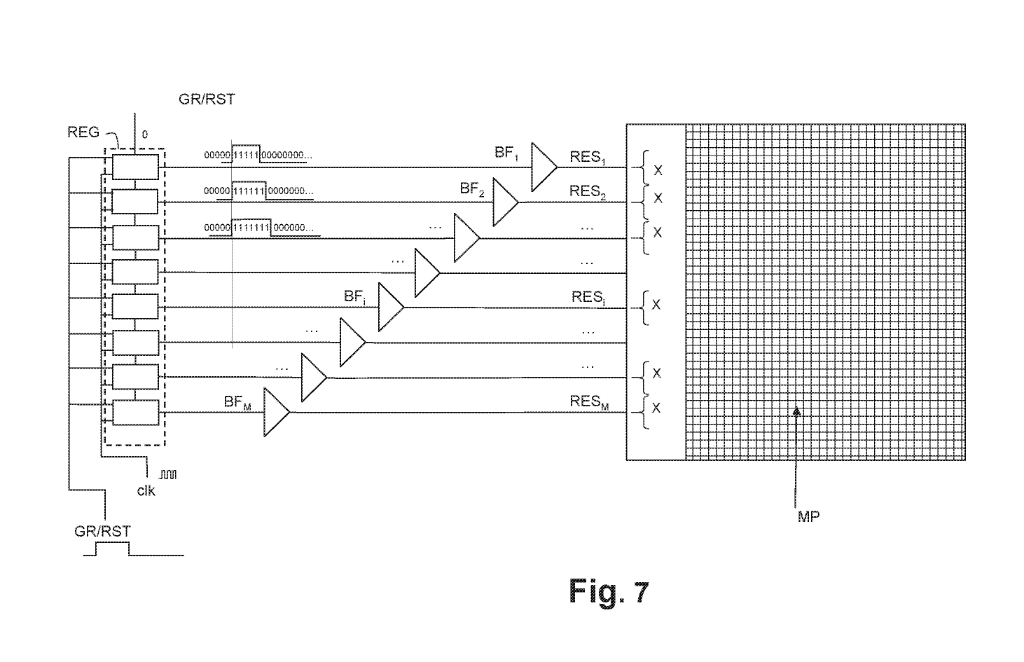

FIG. 7 represents a third embodiment.

The pixel of FIG. 1 is a conventional pixel of MOS technology with three transistors (3T pixel) that can be used in a matrix of rows and columns of pixels. It comprises a photodiode PH, a transistor T1 for resetting the potential of the photodiode, a read transistor T2, and a row select transistor T3.

The reset transistor T1 is connected between the cathode of the photodiode PH and a power supply voltage Vref. It is made to conduct by a global reset signal GR. The conduction of the transistor T1 empties the photodiode of its charges with a view to a new integration period. The period of integration of charges generated by the light begins at the end of the reset signal.

The read transistor T2 is a transistor mounted as voltage follower, with the gate linked to the cathode of the photodiode, and the drain connected to the power supply. On its source, it copies, to within the gate-source voltage, the potential present on its gate; the latter is representative of the quantity of charges accumulated in the photodiode.

The row select transistor T3 is connected between the source of the transistor T2 and a column conductor common to all the pixels of a same column of the matrix of pixels. Its gate is controlled by a row select conductor SEL common to all the pixels of a same row of pixels.

This pixel is illuminated for a limited time. The integration time for charges resulting from the light begins when the global reset signal is stopped (or when the illumination begins if the illumination begins after). The integration time ends at the end of the period of illumination of the scene observed, that is to say, at the moment of closure (considered instantaneous) of a light shutter or at the moment of the end of a pulse of light illuminating the scene.

The operation of the 3T pixel in a conventional matrix of pixels according to FIG. 1 is as follows: global reset of all the pixels, integration of charges in the photodiode until the end of illumination, and row-by-row read, on the column conductors, of the charges accumulated in the photodiodes. This read is done by read circuits (not represented) located at column base, and the potentials present on the column conductors in a read step are the potentials applied by the transistors T2, T3 of a row of pixels selected by the row select conductor SEL. They represent the quantity of charges accumulated in the photodiode PH.

Another type of pixel (4T or 5T pixel) is represented in FIG. 2. It comprises four or five transistors, or more, and it has a temporary storage node ND and a charge transfer transistor T4 which is used to transfer to the storage node ND the charges accumulated by the photodiode during its illumination. The transistor T4 is made to conduct by a transfer command signal TRA. The charge storage node ND can be reset, on each charge integration period, by a transistor T5 which links it to a reference potential which can be the power supply potential Vref of the matrix of pixels. To this end, the transistor T5 is controlled by a reset signal RST. The transistor T1 which makes it possible to reset the potential of the photodiode under the control of the signal GR is optional (5T pixel).

The operation of the pixel of FIG. 2 does not require any light shutter and the illumination can be continuous. The integration time is that which separates two successive transfer command signals TRA (4T or 5T pixel) or that which separates the signal GR from the signal TRA (5T pixel).

The periodic operations are as follows: integration of charges in the photodiode under the effect of the light from the reset of the photodiode by a signal GR or, in the absence of signal GR, from the preceding transfer of charges from the photodiode to the storage node; global reset of all the storage nodes ND by making the transistors T5 conduct; making the transfer transistors T4 conduct by the transfer signal TRA to transfer into the temporary storage node ND all the charges accumulated by the photodiode; then row-by-row read, on the column conductors, of the charges present in the storage nodes. This read is done by read circuits not represented at column base. The potentials read on the column conductors are those which are applied by the transistors T2 and T3 of a row of pixels selected by the row select conductor SEL. They represent the quantity of charges accumulated in the temporary storage nodes ND.

In the case of the 3T pixel of FIG. 1, the global reset of the photodiode, considered here as a charge storage zone, is conventionally done by a single general reset signal GR applied simultaneously to all the pixels. In the case of the pixel of FIG. 2, the global reset of the temporary charge storage node is conventionally done by a single general reset signal RST applied simultaneously to all the pixels.

In both cases, as indicated previously, this single general signal GR or RST applied to all the pixels of the matrix creates, by capacitive coupling, fluctuations of the power supply potential Vref, the latter originating from a voltage source with finite internal impedance. The storage nodes of the pixels are reset to a potential which is the value of the power supply potential when the reset transistor T1 or T5 is blocked, that is to say on the falling edge of the reset command signal. However, this blocking occurs exactly at the moment when a potential fluctuation occurs, which makes the reset value imprecise. That is all the more true as the blocking of the transistors does not occur exactly at the same moment for all the pixels, if only because of the variable propagation times of the command signal GR or RST to the different pixels.

To reduce the light measurement errors due to these fluctuations, the invention proposes temporally distributing the general global reset signal to the groups of rows of pixels at instants that are slightly staggered and controlled relative to one another instead of applying a same signal to all the rows by direct connectivity. More specifically, the falling edges of individual reset command signals are staggered, while retaining a mutual overlapping of these individual signals. This temporal distribution spread out over all the matrix considerably reduces the potential fluctuations which would exist if the falling edges of the reset command signals were simultaneous. There is no need for each row to receive a falling edge different from that of all the other rows. A common falling edge can be applied to a group of X rows, and the matrix comprises at least M groups of rows which receive different falling edges from one group to another. M is greater than 2. X is greater than or equal to 1 and preferably X is greater than 10.

The shift time is very small and preferably at least 100 times smaller than the duration of each individual reset signal. Typically, the shift between two successive individual reset signals does not exceed 10 ns/row (in other words, 10·X ns), and preferably 1 ns/row.

FIG. 3 represents the matrix of pixels MP, with the circuit making it possible to establish M individual reset command signals from a general global reset command signal.

The general reset signal GR (matrix of 3T pixels) or RST (matrix of 4T or 5T pixels) is applied to a series assembly of M delay elements which delay this logic signal by a time dT which is preferably, but not obligatorily, identical from one delay element to the next. The outputs of the delay elements are applied to respective buffer amplifiers BF₁ to BF_{M}; the output of the amplifier BFᵢ of rank i is applied to a group of X row conductors which control the reset transistors T1 (FIG. 1) or T5 (FIG. 2) of a group of X rows of pixels. This output of buffer amplifier BFᵢ delivers an individual reset signal RESᵢ of rank i, intended solely for this group.

The general global reset signal is long enough to ensure the resetting of the pixels. The different signals RESᵢ have a partial or total mutual overlap relative to one another; preferably, the overlap is total and all the individual reset signals overlap for a time common to all, that is to say that the rising edge of the last signal RES_{M} occurs before the falling edge of the first signal RES₁.

The basic delay dT can be produced using two logic inverters in series and the value of the delay can then be from 200 to 500 picoseconds. The duration of the signal RST or GR can be from approximately 1 microsecond to 10 microseconds. The groups of rows can comprise, for example, from 1 row to 100 rows.

FIG. 4 represents the common reset command signal GR in the case of a 3T pixel, and the individual reset command signals RESᵢ corresponding to the different groups of rows. The illumination LUM is provided periodically. It begins before or after the reset. The integration time Ti begins after the reset, i.e. at the end of the reset if the illumination has already begun, or at the start of the illumination; the integration time lasts until the illumination stops, the stop resulting from the operation of a shutter (the shutter is here considered to instantaneously interrupt the light over all the matrix) or from the interruption of a flash of light. The reading of the charges accumulated in the photodiode is done row by row after the end of the integration time and it lasts for a time T_{L}. The illumination is interrupted during the read. The timescales are not observed in the figures in the interests of legibility of the timing diagrams. The detail of the read operations is not represented.

The general global reset command signal has a rising edge at an instant t₀. The individual reset command signals have rising edges which are staged between the instants t₀ and t₁, and falling edges which are staged by increments of dT between times t₂ and t₃. In the case of FIG. 4, the signals all mutually overlap during the time interval t₁−t₂, but this is not obligatory: it would be possible to have a progressive overlap between the signals, the last signals (RES_{M} for example) having no overlap with the first (RES₁ for example). It will be noted that the time shift dT of the falling edges is not necessarily equal to the time shift of the rising edges when these shifts are very small; in effect, the shifts depend on the reaction times of the components used, for example bipolar or PMOS or NMOS transistors, or resistors.

FIG. 5 represents, in the case of a 5T pixel, the common global reset command signal RST, and the individual reset command signals corresponding to the different groups of rows.

For a 5T pixel, the global signal RST which is used to reset the storage nodes is sent after a reset signal GR for the photodiode and before a global transfer signal TRA applied to all the pixels of the matrix. The reading of the charges accumulated in the storage node is done row by row after the signal TRA, while the photodiodes once again accumulate charges resulting from the illumination. The illumination can be continuous or pulsed. The integration time Tᵢ goes from the end of the signal GR to the end of the signal TRA which follows it. In the case of a 4T pixel, there is no signal GR. The integration time then extends from one transfer signal TRA to the next. In both cases, it is the resetting of the intermediate storage nodes which is concerned and which, from a general global reset command signal RST, will produce individual signals RESᵢ to the transistors T5 of FIG. 2.

Consequently, the issue is, particularly, to obtain a global reset of the storage nodes of all the pixels, this reset being simultaneous in principle so that all the storage nodes are reset almost at the same moment, but very slightly staggered in practice to reduce the reset noise. The shift between the falling edges of two successive individual command signals is preferably less than a hundredth and preferably less than a thousandth of the duration of the general command signal RST.

The production of the individual reset command signals RESᵢ from a global signal RST can be done by delay elements as explained with reference to FIG. 3.

FIG. 6 represents a variant embodiment of the invention. Instead of using M delay elements of duration dT which progressively shift the rising edge and the falling edge of a general global reset command signal GR or RST, a shift register REG of M flip-flops FF in series is used, actuated by a clock clk, the period of which is equal to the desired delay dT (which, in this case, rather has a value of 5 to 10 ns). The input of the register receives a succession of several 1 bits at the rate of the clock clk and the register propagates this succession of 1 bits from flip-flop to flip-flop; the number of successive 1 bits defines the duration of the general global reset command signal GR or RST, after which 0 bits are introduced on the serial input and propagated to the outputs of the flip-flops; the flip-flops actuated at the rate clk therefore each provide the series of 1 bits, which is reflected on the output of the flip-flops by a signal that is the image of the signal GR or GRST but shifted by a maximum of one clock pulse for the first flip-flop, by i clock clk pulses for the i^{th} flip-flop, and by M clock pulses for the last flip-flop. The outputs of the flip-flops are linked by respective buffer amplifiers BF₁ to BF_{M} which supply the individual command signals RES₁ to RES_{M}. Each signal is applied to a group of X row conductors of the matrix. These row conductors control the gates of the reset transistors T1 (3T pixels) or T5 (4T or 5T pixels).

If the number of 1 bits introduced on the input of the register REG at the rate of the clock is greater than M, the output signals of the flip-flops have an overlap time common to all.

FIG. 6 shows a direct link between the output of a flip-flop of rank i and the input of a following flip-flop of rank i−1. However, it would be possible to provide for the input of the flip-flop of rank i+1 to receive the input or the output of the amplifier of rank i.

FIG. 7 represents yet another embodiment, applicable to the matrices of 3T or 4T or 5T pixels, in which another shift register with M flip-flops having a serial input is used, but these flip-flops are provided also with command inputs for forcing their output to the logic 1 state. The forcing command signal is the global command signal GR or RST. All the flip-flops are initially brought to the logic 1 value for the duration of the general global reset command signal, which is reflected by a reset command level applied from the start of the global signal GR or RST to all the transistors T1 (3T pixels) or T5 (4T, 5T pixels) of the matrix. The duration of the general global reset command signal is the minimum duration necessary to reset the first group of X rows.

Moreover, the flip-flops of the register receive a clock clk in the same way as in the circuit of FIG. 6. The clock advances the content of the register step by step, by, on each clock pulse, transferring the output state of one flip-flop to the output of the next flip-flop. A fixed zero logic level is established at the serial input of the register, that is to say at the input of the first flip-flop, at the end of the duration of the general global reset command signal GR or RST. This zero level interrupts, when it appears at the output of a flip-flop, the individual command signal produced by that flip-flop. It therefore determines the falling edge of this signal. This interruption occurs progressively, with a shift by a clock period, from one flip-flop to the next.

The result thereof is individual command signals RESᵢ which all have the same rising edge but which have falling edges shifted by one clock period from one flip-flop to the next. The duration of the global command signal is equal to M×dT if dT is the clock period. The durations of the individual signals are not identical but are staged by dT increments from the duration of the signal GR or RST. The individual reset command signals totally overlap for the duration of the signal GR or RST.

In the above, a simple organization has been considered with M groups of rows and a delay between two successive groups of rows. An organization could be provided with a more complex hierarchy in which a group of rows is broken down into several subgroups with delays between subgroups that are different from the delays between groups. There is then a temporal distribution of reset signals, with mutual overlap, not only between groups but also within a group.

It will be noted that the temporal distribution of the delays may affect only a part of the matrix and not all.

1. A method for performing global reset of storage zones for charges generated by light in pixels of a matrix image sensor comprising rows and columns of pixels, before a row-by-row read of the charges generated by the light, comprising the steps of:
establishing a general global reset command signal having a rising edge and a falling edge,
from this general global reset command signal, producing M>1 individual reset command signals that are mutually overlapping and that have falling edges slightly staggered in time relative to one another and relative to the general global reset signal, by means of circuit elements other than a simple conductor,
and applying each individual reset command signal to a respective group of X rows of pixels, X being an integer greater than or equal to 1.

2. The method of claim 1, wherein the M individual reset command signals are produced from the general global reset command signal and from M cascaded delay elements, a first of which receives the general global reset signal, outputs of the M delay elements supplying the M individual reset command signals having staggered falling edges.

3. The method of claim 1, wherein the M individual reset command signals are produced from a shift register with serial input and parallel outputs, wherein a shift is controlled by a clock signal of period dT, the general global reset signal being a logic signal, comprising a series of successive bits of a same logic level applied to the input of the shift register, the M individual reset command signals being obtained from the outputs of the shift register.

4. The method of claim 1, wherein the M individual reset command signals are produced from outputs of a shift register with M flip-flops having a serial input, parallel outputs and means for setting a high logic state simultaneously for all the M flip-flops, in which the M flip-flops are initially set to the high logic state, then a low logic level is introduced on the serial input and a shift of the shift register is actuated with a period dT while a state of the serial input remains at the low logic level.

5. The method of of claim 1, wherein the pixels are pixels with at least four transistors and a photodiode, having a transistor for transferring charges from the photodiode to a charge storage node, a transistor for resetting the charge storage node, and the global reset is a reset of the charge storage node before a transfer of charges for a differential read of a level of useful charges after this transfer and of a reset level before this transfer.

6. The method of claim 1, wherein the pixels are pixels with three transistors and a photodiode and the global reset is a reset of the photodiode by means of one of the transistors for all the pixels of the matrix.

7. An image sensor comprising a matrix of rows and columns of pixels with at least four transistors and a photodiode with a charge storage zone and a charge transfer transistor between the photodiode and the charge storage zone, the sensor comprising means for globally resetting the storage zone of all the pixels before a global transfer of charges from the photodiodes of all the pixels to the respective storage zones and before a row-by-row read of the charges generated by light, further comprising:
means for establishing a general global reset command signal having a rising edge and a falling edge,
means for producing, from this signal, M>1 individual reset command signals that are mutually overlapping that have falling edges slightly staggered in time relative to one another by means of elements of circuits other than a simple conductor,
and means for applying each individual reset command signal to a respective group of X rows of pixels, X being an integer greater than or equal to 1.

8. The image sensor of claim 7, wherein the means for producing the M individual reset command signals comprise a series of M cascaded delay elements.

9. The image sensor of claim 7, wherein the means for producing M individual reset command signals comprise a shift register with M flip-flops, the outputs of the flip-flops each controlling a group of X rows of pixels.

10. An image sensor comprising a matrix of rows and columns of pixels with three transistors and a photodiode, capable of collecting, in the respective photodiode of each pixel, charges generated by light, the sensor comprising means for globally resetting the photodiodes of all the pixels before a row-by-row read of the charges generated by the light during an integration period common to all the pixels and defined for all the pixels from the end of a general global reset command signal having a rising edge and a falling edge, further comprising:
means for producing, from this general global reset command signal, M>1 individual reset command signals that are mutually overlapping and that have falling edges slightly staggered in time relative to one another, by means of circuit elements other than a simple conductor,
and means for applying each individual reset command signal to a respective group of X rows of pixels, X being an integer greater than or equal to 1.

11. An imaging system without vertical rolling mechanical shutter, comprising an image sensor comprising a matrix of rows and columns of pixels capable of collecting, in a respective charge storage zone for each pixel, charges generated by light, an orientation of said columns defining a so-called vertical direction, the sensor comprising means for resetting the storage zone of each pixel a row-by-row read of the charges generated by light, the sensor further comprising:
means for establishing a general global reset command signal having a rising edge and a falling edge,
means for producing, from this signal, M>1 individual reset command signals that are mutually overlapping and having falling edges slightly staggered in time relative to one another, by means of circuit elements other than a simple conductor,
and means for applying each individual reset command signal to a respective group of X rows of pixels, X being an integer greater than or equal to 1.
